(19) United States
(12) Patent Application Publication
(10) Pub. No.: US 2026/0112885 A1
(43) Pub. Date: Apr. 23, 2026

(54) ENERGY STORAGE APPARATUS

(71) Applicant: GS Yuasa International Ltd., Kyoto-shi (JP)

(72) Inventors: Shota OKAMOTO, Kyoto-shi (JP); Shoichi ARIMOTO, Kyoto-shi (JP); Yasuji NAKAMURA, Kyoto-shi (JP)

(21) Appl. No.: 19/425,339

(22) Filed: Dec. 18, 2025

Related U.S. Application Data
(63) Continuation of application No. PCT/JP2024/021595, filed on Jun. 14, 2024.

(30) Foreign Application Priority Data
Jun. 20, 2023 (JP) 2023-100577

(51) Int. Cl. H02H 7/22; H01M 10/42; H01M 10/48; H02J 7/63

(52) U.S. Cl. CPC H02H 7/222; H01M 10/4257; H01M 10/482; H02J 7/63

(57) ABSTRACT

An energy storage apparatus includes a protection circuit including a cutoff control switch connected to first and second semiconductor switches provided in series on a power line to simultaneously turn off the first and second semiconductor switches, a reuse prohibition switch provided in series with the cutoff control switch, and a latch circuit. The protection circuit is configured to turn off the first and second semiconductor switches without latching the reuse prohibition switch by the latch circuit when executing first protection, which allows restoration of operation after the first and second semiconductor switches are turned off, and to turn off the first and second semiconductor switches while latching the reuse prohibition switch by the latch circuit when executing second protection, which prohibits the restoration of the operation after the first and second semiconductor switches are turned off.

### CROSS REFERENCE TO RELATED APPLICATIONS

This application claims the benefit of priority to Japanese Patent Application No. 2023-100577 filed on Jun. 20, 2023 and is a Continuation Application of PCT Application No. PCT/JP2024/021595 filed on Jun. 14, 2024. The entire contents of each application are hereby incorporated herein by reference.

### BACKGROUND OF THE INVENTION

### 1. Field of the Invention

The present invention relates to energy storage apparatuses.

### 2. Description of the Related Art

Generally, in motorcycles, a lead battery is used as an energy storage apparatus for starting an engine of the motorcycle. However, in Japanese Unexamined Patent Application Publication No. 2020-167766, an energy storage apparatus including a plurality of lithium-ion secondary batteries (energy storage devices) is applied to a motorcycle.

In Japanese Unexamined Patent Application Publication No. 2020-167766, as a circuit breaker for protection of the energy storage devices, a field-effect transistor (FET) is provided between a negative electrode of the energy storage device and a negative terminal of the energy storage apparatus (that is, on a low side of the energy storage device). The FET is turned off (opened) when an abnormal event of the energy storage devices, such as overcharge or overcurrent, occurs.

### SUMMARY OF THE INVENTION

Example embodiments of the present invention provide energy storage apparatuses each capable of preventing thermal destruction of a semiconductor switch, and for which a plurality of kinds of protective functions can be implemented by a hardware circuit.

An energy storage apparatus according to an example embodiment of the present invention includes an energy storage device, a positive terminal and a negative terminal, a power line connecting the positive terminal, the energy storage device, and the negative terminal to each other, a first semiconductor switch and a second semiconductor switch provided in series on the power line, and a protection circuit including a cutoff control switch connected to the first and second semiconductor switches to simultaneously turn off the first and second semiconductor switches, a reuse prohibition switch provided in series with the cutoff control switch, and a latch circuit, in which the protection circuit is configured to cause the first and second semiconductor switches to be turned off without latching the reuse prohibition switch by the latch circuit when executing first protection, which allows restoration of operation after the first and second semiconductor switches are turned off, and to cause the first and second semiconductor switches to be turned off while latching the reuse prohibition switch by the latch circuit when executing second protection, which prohibits the restoration of the operation after the first and second semiconductor switches are turned off.

An energy storage apparatus according to another example embodiment of the present invention includes an assembled battery including a plurality of energy storage devices, a first monitoring circuit to monitor each of the energy storage devices and a second monitoring circuit to monitor the assembled battery, a positive terminal and a negative terminal, a power line connecting the positive terminal, the assembled battery, and the negative terminal to each other, a first semiconductor switch and a second semiconductor switch provided in series on the power line, a cutoff control switch connected to the first and second semiconductor switches to simultaneously turn off the first and second semiconductor switches, a latch circuit, and a reuse prohibition switch provided in series with the cutoff control switch to be latched by the latch circuit when a first abnormality is detected by the first monitoring circuit and when a second abnormality is detected by the second monitoring circuit, and to maintain a latched state even when the first abnormality and/or the second abnormality is resolved.

According to the above example embodiments, it is possible to provide energy storage apparatuses each capable of preventing thermal destruction of the first and second semiconductor switches provided on the power line by simultaneously turning off the first and second semiconductor switches, and for which a plurality of kinds of protective functions can be implemented by a hardware circuit.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a side view of a motorcycle.

FIG. 2 is a block diagram of a vehicle system.

FIG. 3 is an exploded perspective view illustrating a configuration example of an energy storage apparatus.

FIG. 4 is an electrical block diagram illustrating a configuration example of an energy storage apparatus.

FIG. 5 is a diagram for describing a circuit operation of a case where a low voltage abnormality of an energy storage apparatus is detected.

FIG. 6 is a diagram for describing a function of a protection circuit.

FIG. 7 is a diagram illustrating details of the protection circuit.

FIG. 8 is a diagram for describing protection performed when a low voltage abnormality (over-discharge) is exhibited.

FIG. 9 is a diagram for describing cancellation of overdischarge protection.

FIG. 10 is a diagram for describing protection performed when overvoltage is exhibited.

FIG. 11 is a diagram for describing maintaining of the protection when the overvoltage is no longer exhibited.

FIG. 12 is a diagram for describing protection performed when a cell deep discharge is exhibited.

FIG. 13 is a diagram for describing maintaining of the protection when the cell deep discharge is no longer exhibited.

FIG. 14 is a diagram for describing protection performed when a battery deep discharge is exhibited.

FIG. 15 is a diagram for describing maintaining of the protection when the battery deep discharge is no longer exhibited.

FIG. 16 is a diagram illustrating modes of protection corresponding to signals output from a first terminal and a second terminal of a battery monitoring IC.

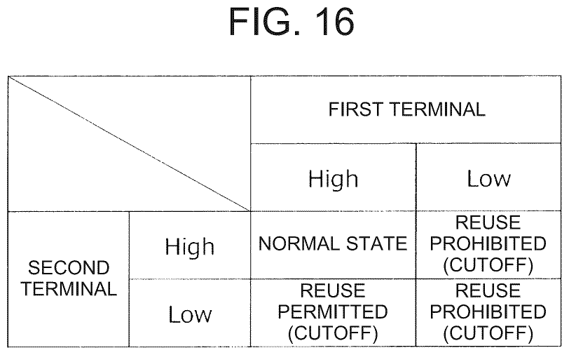

FIG. 17 is a diagram illustrating a case of an external short circuit which has occurred in a state in which a charge cutoff FET is turned off and a discharge cutoff FET is kept turned on in order to protect an energy storage device from being overcharged.

### DETAILED DESCRIPTION OF THE EXAMPLE EMBODIMENTS

In the following, an outline of example embodiments will be described.

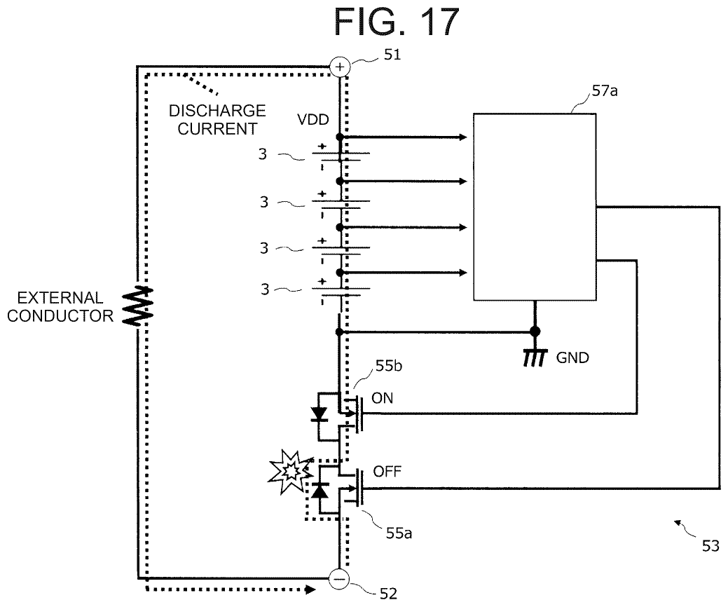

In order to reduce the number of booster circuits (charge pump circuits and switching regulator circuits) for gate voltage generation of an N-channel FET, the inventors of example embodiments of the present invention have considered arranging the N-channel FET on a low side of an energy storage device 3, as illustrated in FIG. 17.

Alternatively, while a P-channel FET may be arranged on a high side of the energy storage device 3, an on-resistance of the P-channel FET is higher than that of the N-channel FET. For this reason, in order to ensure a current-carrying capability equivalent to that of the N-channel FET, it is necessary to increase the number of P-channel FETs connected in parallel, which means that a board size is increased and a cost is increased.

In the example of an energy storage apparatus of FIG. 17, a management controller 53 includes a discharge cutoff FET 55b and a charge cutoff FET 55a, which are connected in series such that directions of parasitic diodes (body diodes) of these FETs are opposite to each other, and a monitoring IC (integrated circuit) 57a.

In order to protect the energy storage device 3 from being overcharged, the monitoring IC 57a causes the charge cutoff FET 55a to be turned off and the discharge cutoff FET 55b to be kept turned on. By virtue of the turned-off charge cutoff FET 55a, a charge of the energy storage device 3 is prohibited (i.e., the parasitic diode incorporated therein blocks a charging current), but a discharge of the energy storage device 3 via the parasitic diode is permitted. In this state, when a positive terminal 51 and a negative terminal 52 of the energy storage apparatus are short-circuited via an external conductor (externally short-circuited), a large current (a discharge current) indicated by a broken line flows through the parasitic diode of the charge cutoff FET 55a. Consequently, there is a possibility that the charge cutoff FET 55a may be thermally destructed by a temperature rise caused by a power loss in the parasitic diode.

Although not illustrated, in order to protect the energy storage device 3 from being over-discharged, the monitoring IC 57a causes the discharge cutoff FET 55b to be turned off and the charge cutoff FET 55a to be kept turned on. By virtue of the turned-off discharge cutoff FET 55b, a discharge of the energy storage device 3 is prohibited (i.e., the parasitic diode incorporated therein blocks a discharge current), but a charge of the energy storage device 3 via the parasitic diode is permitted. In this state, when the positive terminal 51 and the negative terminal 52 of the energy storage apparatus are connected to another vehicle (battery) via a booster cable and a jump start is attempted, a large current (a charging current) flows through the parasitic diode of the discharge cutoff FET 55b. Consequently, there is a possibility that the discharge cutoff FET 55b may be thermally destructed by a temperature rise caused by a power loss in the parasitic diode.

Therefore, the inventors of the present invention have conceived of the following example embodiments.
(1) An energy storage apparatus includes an energy storage device, a positive terminal (a positive external terminal) and a negative terminal (a negative external terminal), a power line connecting the positive terminal, the energy storage device, and the negative terminal to each other, a first semiconductor switch and a second semiconductor switch provided in series on the power line, and a protection circuit including a cutoff control switch connected to the first and second semiconductor switches to simultaneously turn off the first and second semiconductor switches, a reuse prohibition switch provided in series with the cutoff control switch, and a latch circuit, in which the protection circuit is configured to cause the first and second semiconductor switches to be turned off without latching the reuse prohibition switch by the latch circuit when executing first protection, which allows restoration of operation after the first and second semiconductor switches are turned off, and to cause the first and second semiconductor switches to be turned off while latching the reuse prohibition switch by the latch circuit when executing second protection, which prohibits the restoration of the operation after the first and second semiconductor switches are turned off.

Here, the “semiconductor switch” may be a metal-oxide-semiconductor (MOS) FET, but is not limited to this form. The semiconductor switch may be a bipolar transistor, an Insulated Gate Bipolar Transistor (IGBT), or a gallium nitride (GaN) heterojunction transistor.

From the standpoint of a balance between performance and the cost, N-channel MOSFETs can be used as the first and second semiconductor switches.

While the “cutoff control switch” and the “reuse prohibition switch” may be P-channel MOSFETs, they are not limited to this form. The cutoff control switch and the reuse prohibition switch may be included in the protection circuit, or may be provided on a circuit board constituting the protection circuit.

The “power line” and the “first semiconductor switch and the second semiconductor switch” may also be provided on the circuit board constituting the protection circuit.

According to the energy storage apparatus of (1) described above, it is possible to prevent thermal destruction of the first and second semiconductor switches provided on the power line by simultaneously turning off the first and second semiconductor switches. That is, by simultaneously turning off the first and second semiconductor switches, it is possible to prevent thermal destruction of the switch due to a large current flowing through a parasitic diode of one of the semiconductor switches.

According to the energy storage apparatus of (1) described above, not only the first protection which allows restoration of operation but also the second protection, which accompanies prohibition of the operation restoration of the energy storage apparatus, can be implemented by latching the reuse prohibition switch. As a result, it is possible to forcibly prevent use of an energy storage apparatus which is in a state in which the restoration of the operation is not desirable, and reliability of the energy storage apparatus can be improved.

The protection circuit which executes the first protection and the second protection can be configured by a hardware circuit which operates according to the state (for example, a potential) of each portion (a terminal of a switch or the like) of the energy storage apparatus, in other words, a circuit which does not require software or a central processing unit (CPU). As the hardware circuit is adopted, it is possible to avoid an increase in the cost due to the use of a CPU (for example, a microcomputer).
(2) An energy storage apparatus includes an assembled battery including a plurality of energy storage devices, a first monitoring circuit to monitor each of the energy storage devices and a second monitoring circuit to monitor the assembled battery, a positive terminal and a negative terminal, a power line connecting the positive terminal, the assembled battery, and the negative terminal to each other, a first semiconductor switch and a second semiconductor switch provided in series on the power line, a cutoff control switch connected to the first and second semiconductor switches to simultaneously turn off the first and second semiconductor switches, a latch circuit, and a reuse prohibition switch provided in series with the cutoff control switch to be latched by the latch circuit when a first abnormality is detected by the first monitoring circuit and when a second abnormality is detected by the second monitoring circuit, and to maintain a latched state even when at least one of the first abnormality or the second abnormality is resolved.

According to the energy storage apparatus of (2) described above, it is possible to prevent thermal destruction of the first and second semiconductor switches provided on the power line by simultaneously turning off the first and second semiconductor switches. That is, by simultaneously turning off the first and second semiconductor switches, it is possible to prevent thermal destruction of the switch due to a large current flowing through a parasitic diode of one of the semiconductor switches.

According to the energy storage apparatus of (2) described above, in both cases of the first abnormality which is detected by the first monitoring circuit and the second abnormality which is detected by the second monitoring circuit, prohibition of the operation restoration of the energy storage apparatus can be realized by means of a hardware circuit by latching the reuse prohibition switch. That is, it becomes possible to adapt to both of an abnormality mode in which the abnormality can be detected by monitoring the energy storage device and an abnormality mode (for example, an abnormality mode which leads to an abnormal operation of a BMU, which will be described later) in which the abnormality can be detected by monitoring the assembled battery. Thus, the reliability of the energy storage apparatus can be improved. By adopting the reuse prohibition switch which can be switched by a signal instead of a component which melts down such as a fuse, operation confirmation of the reuse prohibition can be carried out in a manufacturing process.

It is preferable that the same reuse prohibition switch should be used in both cases of the first abnormality of the energy storage device which is to be detected by the first monitoring circuit and the second abnormality of the assembled battery which is to detected by the second monitoring circuit, and it is more preferable that the same latch circuit should be used. As a consequence, the prohibition of the operation restoration of the energy storage apparatus can be realized by a hardware circuit having a small occupied area (a footprint), and cost reduction and downsizing of the energy storage apparatus can be achieved.

The “second abnormality” referred to in the present specification is not limited to the abnormality of the assembled battery itself, and may be any abnormality as long as it is detected by the second monitoring circuit to monitor the assembled battery.
(3) In the energy storage apparatus according to (1) or (2) described above, the first and second semiconductor switches may be provided in series on the power line between the energy storage device and the negative terminal.

According to the above configuration, it is possible to use an N-channel FET whose on-resistance is low as the first and second semiconductor switches, and cost reduction and downsizing of the energy storage apparatus can be achieved.
(4) The energy storage apparatus according to (1) described above may further include a monitoring circuit to monitor the energy storage device, and the protection circuit may be configured to perform the first protection or the second protection according to a combination of a first signal and a second signal that are respectively output from a first terminal and a second terminal of the monitoring circuit.

According to the above configuration, four kinds of combination patterns are obtained when each of the first signal and the second signal can represent two states, which are high and low states. Further, normal operation or different kinds of protective functions of the energy storage apparatus corresponding to each pattern can be implemented by a hardware circuit.
(5) In the energy storage apparatus according to (2) described above, the first abnormality may be a deep discharge of the energy storage device, and the second abnormality may be a deep discharge of the assembled battery.

According to the above configuration, in both cases of the deep discharge of the energy storage device (i.e., a discharge to a state in which the state of charge (SOC) of the energy storage device is lower than 0%) and the deep discharge of the assembled battery, it is possible to prohibit the operation restoration of the energy storage apparatus. There is a case where the assembled battery reaches a deep discharge state even when the energy storage device has not yet reached a deep discharge state. In this case, there is a possibility that various protective functions may not be appropriately executed in a management controller, which will be described later. By detecting not only the deep discharge of the energy storage device but also the deep discharge of the assembled battery and prohibiting the operation restoration of the energy storage apparatus, the reliability of the energy storage apparatus can be further improved.

In the following, specific explanation will be given by referring to the drawings indicating the example embodiments.

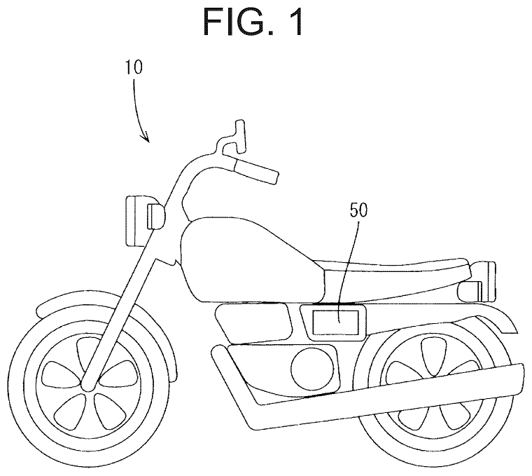

As illustrated in FIG. 1, a battery 50 (an example of the energy storage apparatus) according to an example embodiment is a two-wheeled vehicle battery which is mounted on a motorcycle 10. The battery 50 is rated at 12 volts (V), which allows the battery 50 to be replaced (e.g., retrofitted) from a conventional lead battery.

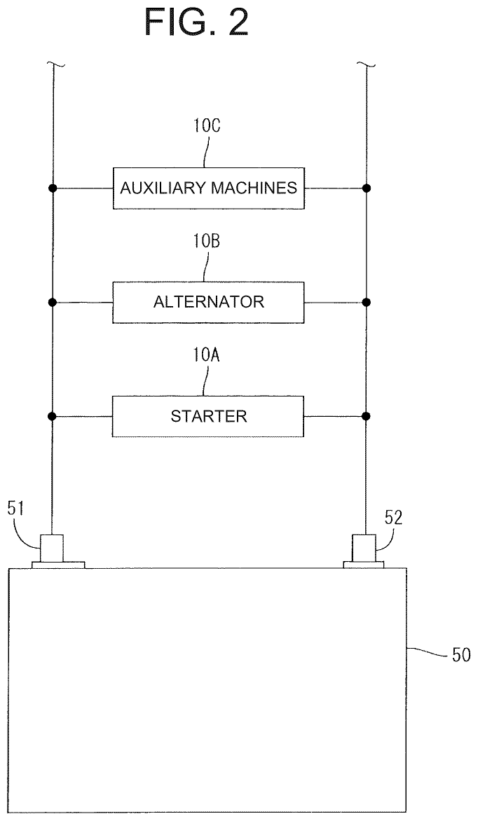

As illustrated in FIG. 2, a starter 10A, an alternator 10B (an example of a vehicular battery charger), and auxiliary machines 10C (a headlight, a car navigation system, and the like), which are mounted on the motorcycle 10, are connected to the battery 50. The battery 50 supplies electric power of 12 V to the starter 10A to start an engine (an internal-combustion engine). The battery 50 is charged by the alternator 10B when the engine is being operated.

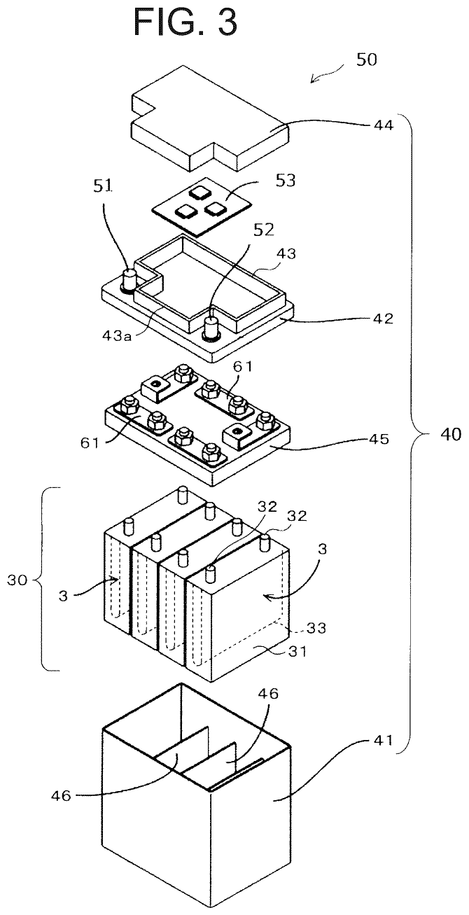

As illustrated in FIG. 3, the battery 50 includes: the management controller 53; a plurality of energy storage cells 3 (an example of the energy storage devices); and an accommodating case 40 having a rectangular parallelepiped shape in which the management controller 53 and the plurality of energy storage cells 3 are accommodated. The energy storage cell 3 may be a battery cell such as a lithium-ion secondary battery, or an electrochemical cell such as a capacitor. The management controller 53 is a battery management controller (BMU) in the present example embodiment.

Four energy storage cells 3 are connected in series to constitute an assembled battery 30. Alternatively, some of these energy storage cells 3 may be connected in parallel. For example, the assembled battery 30 may include eight energy storage cells 3 connected in a two-parallel and four-series configuration, or may include twelve energy storage cells 3 connected in a three-parallel and four-series configuration.

The accommodating case 40 is made of a synthetic resin. The accommodating case 40 includes: a case main body 41; a lid portion 42 which closes an opening portion of the case main body 41; an accommodating portion 43 which is provided on the lid portion 42; a cover 44 which covers the accommodating portion 43; an inner lid (a bus bar frame) 45; and a partition plate 46. The inner lid 45 and the partition plate 46 may not be provided. The energy storage cell 3 is inserted between the partition plates 46 of the case main body 41.

A plurality of metallic bus bars 61 (conductive members) are placed on the inner lid 45. The inner lid 45 is disposed in the vicinity of a terminal surface where cell terminals 32 of the energy storage cells 3 are provided. Thus, the adjacently arranged cell terminals 32 of the adjacently arranged energy storage cells 3 are connected to each other by the bus bar 61, so that the energy storage cells 3 are connected in series.

The accommodating portion 43 is formed in a box shape, and includes, at a central part of one long side of the accommodating portion 43 in a plan view, a projecting part 43a which projects outward. The positive terminal 51 and the negative terminal 52, which are made of a metal such as a lead alloy, are provided on both sides of the projecting part 43a of the lid portion 42. The BMU 53 is accommodated in the accommodating portion 43. The BMU 53 is connected to the energy storage cells 3 via a wiring member (not shown) and the bus bars 61. Instead of being accommodated in the accommodating portion 43, the BMU 53 may be disposed, for example, upwardly or laterally adjacent to the assembled battery 30. The BMU 53 may include a plurality of circuit boards.

The energy storage cell 3 includes a case 31 having a hollow rectangular parallelepiped shape, and a pair of cell terminals 32 and 32 whose polarities are different that are provided on one side surface (terminal surface, upper surface) of the case 31. In the case 31, an electrode body 33 which is formed by stacking a positive electrode, a separator, and a negative electrode over one another, and an electrolyte (an electrolytic solution) which is not illustrated are accommodated.

Although not illustrated in detail, the electrode body 33 is configured by arranging the positive electrode and the negative electrode, which are sheet-shaped, in an overlapping manner with two sheet-shaped separators being interposed, and then winding (vertically winding or horizontally winding) these elements. The separator is formed of a porous resin film. As the porous resin film, a porous resin film made of a resin such as polyethylene (PE) or polypropylene (PP) can be used.

The positive electrode is an electrode plate in which a positive electrode active material layer is formed on a surface of a long band-shaped positive electrode substrate made of, for example, aluminum, an aluminum alloy, or the like. The positive electrode active material layer includes a positive electrode active material. A material capable of absorbing and releasing lithium ions can be used as the positive electrode active material used in the positive electrode active material layer. As the positive electrode active material, LiFePO₄, for example, is used. However, the positive electrode active material is not limited thereto, and a so-called ternary positive electrode active material may be used. The positive electrode active material layer may further include a conductive auxiliary agent, a binder, and the like.

The negative electrode is an electrode plate in which a negative electrode active material layer is formed on a surface of a long band-shaped negative electrode substrate made of, for example, copper or a copper alloy. The negative electrode active material layer includes a negative electrode active material. As the negative electrode active material, a material capable of absorbing and releasing lithium ions can be used. Examples of the negative electrode active material include graphite, hard carbon, and soft carbon. The negative electrode active material layer may further include a binder, a thickener, and the like.

As the electrolyte accommodated in the accommodating case 40 together with the electrode body 33, an electrolyte similar to that of a conventional lithium-ion secondary battery can be used. For example, as the electrolyte, an electrolyte in which a supporting salt is contained in an organic solvent can be used. As the organic solvent, for example, an aprotic solvent such as carbonates, esters, or ethers is used. As the supporting salt, for example, a lithium salt such as LiPF₆, LiBF₄, or LiClO₄ is suitably used. The electrolyte may include, for example, various additives such as a gas generating agent, a coating film forming agent, a dispersing agent, and a thickener.

FIG. 3 illustrates, as an example of the energy storage cell 3, a square lithium-ion battery including the wound-type electrode body 33. Alternatively, the energy storage cell 3 may be a cylindrical lithium-ion battery or a laminated (pouched) lithium-ion battery. The energy storage cell 3 may be a lithium-ion battery including a stacked-type electrode body. The energy storage cell 3 may be an all-solid-state lithium-ion battery using a solid electrolyte.

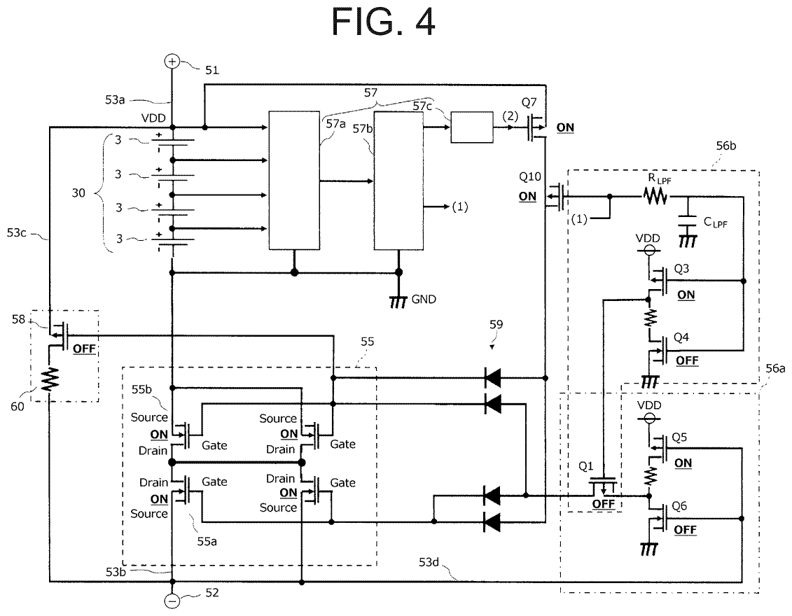

FIG. 4 is an electrical block diagram of the battery 50. The positive terminal 51 and the assembled battery 30 are connected to each other by a power line 53a. Among the four energy storage cells 3 that are connected in series which constitute the assembled battery 30, the energy storage cell which is directly connected to the positive terminal 51 is referred to as a fourth cell. A cell adjacent to the fourth cell is referred to as a third cell, a cell adjacent to the third cell is referred to as a second cell, and a cell adjacent to the second cell is referred to as a first cell. The first cell and the negative terminal 52 are connected to each other by a power line 53b.

At least a part of the power lines 53a and 53b may be constituted by the bus bar 61 (see FIG. 3).

The N-channel FET 55a (a first semiconductor switch) for charge cutoff and the N-channel FET 55b (a second semiconductor switch) for discharge cutoff are provided in series on the power line 53b.

In the present example embodiment, a plurality of FET sets, each including the N-channel FET 55a for charge cutoff and the N-channel FET 55b for discharge cutoff that are provided in series, are provided in parallel with the power line 53b to constitute a cutoff portion 55. A current which flows through the power line 53b is distributed into the plurality of FET sets that are connected in parallel, and is cut off by the plurality of FET sets if an abnormal event occurs.

In the present example embodiment, the N-channel FETs 55a and 55b in each FET set are connected back-to-back with their drain terminals facing inward, i.e., in a drain-common configuration. Alternatively, the FETs 55a and 55b in each FET set may be arranged in an opposite way to the above arrangement so that the FETs 55a and 55b are connected back-to-back in a source-common configuration.

The number of FET sets connected in parallel is set according to the current-carrying capability required for the battery.

The BMU further includes a pull-up wiring line 53c which is provided in parallel with the power lines 53a and 53b, and connects the power line 53a and the negative terminal 52 to each other. A P-channel FET 58 and a resistor 60 which serves as a resistance element are provided in series on the pull-up wiring line 53c. The resistance element may be any element as long as it can generate a resistance component to prevent a short circuit between the positive terminal 51 and the negative terminal 52, and may be an inexpensive passive component.

In the present example embodiment, one end of the pull-up wiring line 53c is connected to a point, which is between the positive terminal 51 and the fourth cell, of the power line 53a, and an other end of the pull-up wiring line 53c is connected to a point, which is between the cutoff portion 55 and the negative terminal 52, of the power line 53b. Since the one end is connected to the point on the power line 53a between the positive terminal 51 and the fourth cell, it is possible to secure a gate-source voltage capable of turning on the P-channel FET 58 even in a state in which cell voltages (V_{cell}1, V_{cell}2, V_{cell}3, and V_{cell}4) of the respective energy storage cells 3 are lowered.

The BMU includes the monitoring IC 57a, a cutoff control circuit 57b, and a latch circuit 57c, and these elements constitute a control portion 57 as a hardware circuit which does not use a CPU. The BMU further includes a reuse prohibition switch Q7 and a cutoff control switch Q10 which are P-channel FETs, an external charge detection portion 56a, a restoration function enabling portion 56b, and a diode 59.

The monitoring IC 57a monitors the state of each cell (for example, the cell voltage), and outputs an abnormality signal to the cutoff control circuit 57b when detecting an abnormality of the battery. As will be described later, the monitoring IC 57a may additionally monitor the state (for example, battery voltage VDD) of the assembled battery 30.

In response to the signal from the monitoring IC 57a, the cutoff control circuit 57b outputs a low or high signal (1), and the latch circuit 57c which receives the signal from the cutoff control circuit 57b outputs a low or high signal (2).

First, with reference to FIG. 4, a circuit operation at a normal time at which no abnormality, such as an overcharge or an over-discharge, has occurred will be described. At the normal time, there is no occurrence of a battery abnormality, and thus, the cutoff control circuit 57b outputs a low (GND) signal as the signal (1), and the latch circuit 57c outputs a low signal as the signal (2). At this time, the reuse prohibition switch Q7 whose source receives an input of a potential of a positive terminal of the fourth cell, i.e., a positive potential (VDD) of the assembled battery 30, and the cutoff control switch Q10 whose source is connected to a drain of the reuse prohibition switch Q7 are both turned on. As a result, a high signal is input to a gate of each of the FETs 55a, 55b, and 58 from a drain of the cutoff control switch Q10 via the diodes 59, and the N-channel FETs 55a and 55b of the cutoff portion 55 are turned on. Thus, the energy storage apparatus can be charged and discharged (i.e., operated normally). The P-channel FET 58 of the pull-up wiring line 53c is turned off.

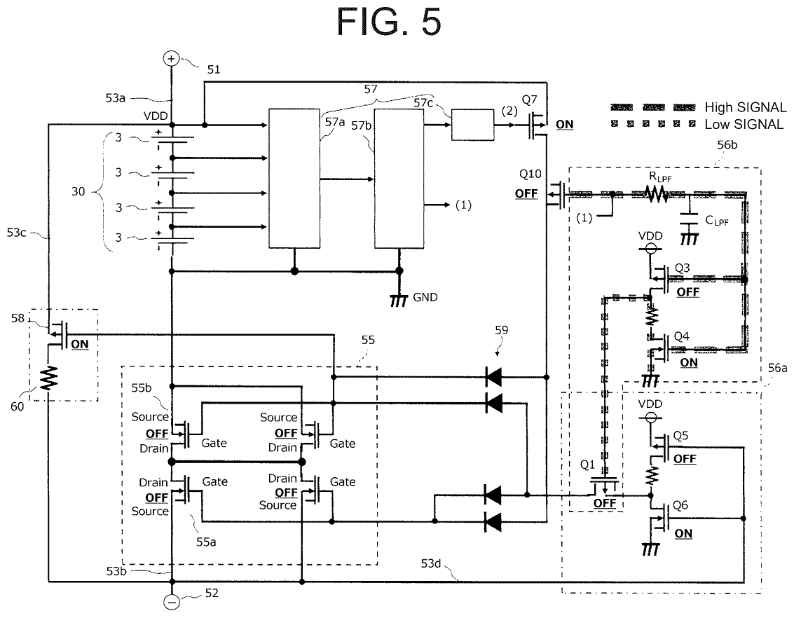

Next, with reference to FIG. 5, a circuit operation of a case where a low voltage abnormality has occurred will be described. In this case, a signal indicating a low voltage abnormality is output from the monitoring IC 57a, and the cutoff control circuit 57b outputs a high (VDD) signal as the signal (1). As a result, the gate-source voltage of the cutoff control switch Q10 becomes substantially zero volts, and the switch Q10 is turned off, so that the N-channel FETs 55a and 55b of the cutoff portion 55 are also turned off. The P-channel FET 58 of the pull-up wiring line 53c is turned on, and a pull-up of the potential of the negative terminal 52 is started.

The restoration function enabling portion 56b includes a push-pull circuit including a switch Q3, which is a P-channel FET, and a switch Q4, which is an N-channel FET. A high signal is input to the push-pull circuit as the signal (1), and the switch Q3 is turned off and the switch Q4 is turned on. Then, a ground (GND) signal is output from the push-pull circuit and input to a gate of an operation restoration switch Q1, which is a P-channel FET.

The operation restoration switch Q1 constitutes a part of the restoration function enabling portion 56b and also constitutes a part of the external charge detection portion 56a.

The external charge detection portion 56a includes a push-pull circuit including a switch Q5, which is a P-channel FET, and a switch Q6, which is an N-channel FET.

An output (VDD or GND) of the push-pull circuit of the external charge detection portion 56a is input to a source of the operation restoration switch Q1. A drain of the operation restoration switch Q1 is connected to the gate of each of the FETs 55a and 55b of the cutoff portion 55 and the gate of the FET 58 via the diodes 59.

As described above, the GND signal output from the push-pull circuit of the restoration function enabling portion 56b is input to the gate of the operation restoration switch Q1, and the operation restoration switch Q1 is set to a standby state (a restoration function enabled state). The standby state is intended as a state in which the N-channel FETs 55a and 55b of the cutoff portion 55 can be turned on again if a voltage (VDD voltage) is applied to the source of the operation restoration switch Q1.

The potential of the negative terminal 52 is pulled up to VDD, and thus, in the push-pull circuit constituted by the switches Q5 and Q6 of the external charge detection portion 56a, the switch Q5 is turned off and the switch Q6 is turned on, as illustrated in FIG. 5. Therefore, a GND signal is input to the source of the operation restoration switch Q1 as the output of the push-pull circuit, and the operation restoration switch Q1 maintains the standby state.

The restoration function enabling portion 56b is provided with a low-pass filter (a delay circuit) constituted by a resistor R_{LPF} and a capacitor C_{LPF}. The low-pass filter is provided in order to adjust a time constant at which a gate voltage of the operation restoration switch Q1 changes from high to low as the switch Q3 is switched from ON to OFF and the switch Q4 is switched from OFF to ON when the low voltage abnormality occurs.

A case where the gate voltage of the operation restoration switch Q1 changes to low before the potential of the negative terminal 52 is changed to high is considered. In this case, since the potential of the negative terminal 52 is low (i.e., in a state before being changed to high), in the push-pull circuit of the external charge detection portion 56a, the switch Q5 is turned on, the switch Q6 is turned off, and the operation restoration switch Q1 is turned on. Although the FETs 55a and 55b of the cutoff portion 55 must be turned off due to the low voltage abnormality, the FETs 55a and 55b are in a state of not being able to be turned off. In view of the above, the time constant of the low-pass filter constituted by the resistor R_{LPF} and the capacitor C_{LPF} is set to be sufficiently longer than the time constant at which the potential of the negative terminal 52 changes from low to high.

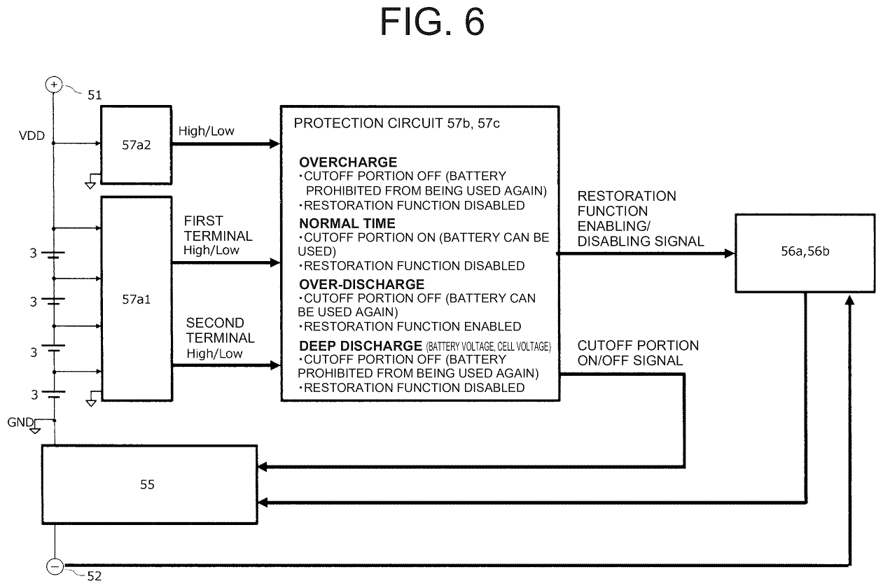

The control portion 57 as the hardware circuit whose outline is illustrated in FIGS. 4 and 5 may have a configuration and functions as illustrated in FIG. 6. The example of FIG. 6 includes: a first monitoring circuit 57a1 which monitors each cell 3; a second monitoring circuit 57a2 which monitors the voltage VDD of the assembled battery (battery); and a protection circuit in which the cutoff control circuit 57b and the latch circuit 57c of FIG. 5 are integrated. The first and second monitoring circuits 57a1 and 57a2 may be separate one-chip ICs.

The first monitoring circuit 57a1 includes a first terminal and a second terminal. The protection circuit 57b, 57c executes, according to a combination of a first signal (high/low) and a second signal (high/low) that are respectively output from the first terminal and the second terminal, either first protection which permits restoration of the battery operation or second protection which prohibits restoration of the battery operation. The first monitoring circuit 57a1 may include additional output terminals.

The turning off of the cutoff portion 55 when an over-discharge (the low voltage abnormality in FIG. 5) is exhibited corresponds to the first protection whereby the battery can be used again.

In contrast, the turning off of the cutoff portion 55 when an overcharge is exhibited, and the turning off of the cutoff portion 55 when a deep discharge is exhibited correspond to the second protection whereby the restoration function of the restoration function enabling portion 56b is disabled and the battery is prohibited from being used again.

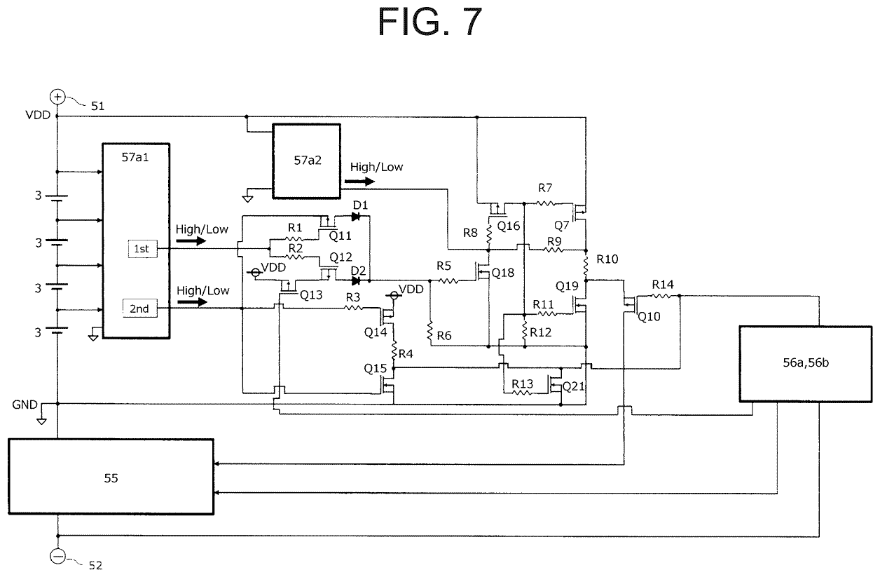

FIG. 7 shows the details of the first and second monitoring circuits 57a1 and 57a2 and the protection circuit.

The first monitoring circuit 57a1 outputs a signal (high/low) from each of the first terminal and the second terminal according to the state of each of the plurality of cells 3 to be monitored. The second monitoring circuit 57a2 outputs a signal (high/low) from an output terminal according to the battery voltage VDD to be monitored.

An output of the first terminal is input to each of gates of switches (P-channel FETs) Q11 and Q12 via resistors R1 and R2, which are provided on the branched wiring lines, respectively. The switch Q11 is used for overvoltage protection which will be described later, and the switch Q12 is used for cell deep discharge protection which will be described later.

An output of the second terminal is input to a source of the switch Q11, and is also input to a gate of a switch (P-channel FET) Q14 via a resistor R3, and to a gate of a switch (N-channel FET) Q15. In the switch Q14, a source is connected to the battery voltage VDD, and a drain is connected to a drain of the switch Q15 via a resistor R4. A source of the switch Q15 is connected to the GND. The switches Q14 and Q15 constitute a push-pull circuit which uses a signal from the second terminal as an input. An output of the push-pull circuit is input to a gate of the cutoff control switch Q10 via a resistor R14.

A source of the switch Q12 is connected to a drain of a switch (P-channel FET) Q13. A source of the switch Q13 is connected to the battery voltage VDD. A signal from the restoration function enabling portion 56b is input to a gate of the switch Q13.

Drains of the switches Q11 and Q12 are connected, via diodes D1 and D2, respectively, to a gate of a switch (N-channel FET) Q18 through a resistor R5, and are connected to a source of the switch (N-channel FET) Q18, a source of a switch (N-channel FET) Q19, and the GND through a resistor R6. A drain of the switch Q18 is connected to the output terminal of the second monitoring circuit 57a2, and also connected to a gate of a switch (P-channel FET) Q16 via a resistor R8. As will be described later, the switch Q18 turns on the switch Q16 to trigger a latch operation.

A source of the switch Q16 is connected to the battery voltage VDD. A drain of the switch Q16 is connected to a gate of the reuse prohibition switch Q7 via a resistor R7. Also, the drain of the switch Q16 is connected to a gate of a switch Q19 through a resistor R11, and is connected to the GND through a resistor R12. Further, the drain of the switch Q16 is connected to a gate of a switch (N-channel FET) Q21 via a resistor R13.

A source of the reuse prohibition switch Q7 is connected to the battery voltage VDD. The drain of the reuse prohibition switch Q7 is connected, via a resistor R10, to a drain of the switch Q19 and a source of the cutoff control switch Q10, which are respectively provided on the branched wiring lines.

The drain of the cutoff control switch Q10 is connected to the cutoff portion 55, and the ON or OFF of the cutoff control switch Q10 turns on or off the first and second semiconductor switches of the cutoff portion 55.

The gate of the cutoff control switch Q10 is connected to a drain of the switch Q21 and the drain of the switch Q15 via the resistor R14.

The source of the switch Q19 and a source of the switch Q21 are connected to the GND.

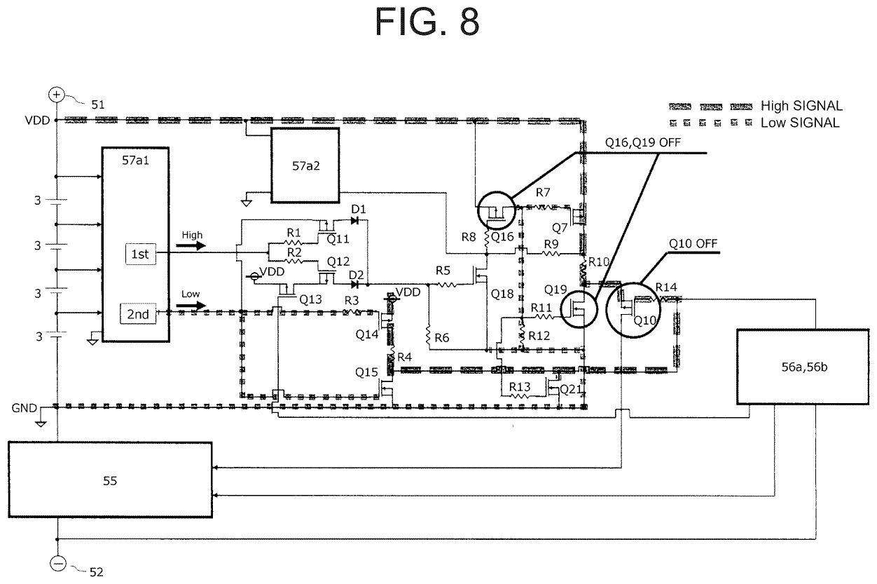

With reference to FIG. 8, the turning off of the cutoff portion 55 when an over-discharge (the low voltage abnormality in FIG. 5) is exhibited will be described.

When the voltage of a certain cell 3 becomes less than or equal to a predetermined lower limit threshold value, an output of the second terminal of the first monitoring circuit 57a1 changes from high to low. By this change, the switch Q14 is turned on, a high signal (corresponding to the signal (1) in FIG. 5) is input to the gate of the cutoff control switch Q10, and the switch Q10 is turned off. As the cutoff control switch Q10 is turned off, the cutoff portion 55 is turned off. At this time, the switches Q16 and Q19 are kept turned off, and a GND signal is input to the gate of the reuse prohibition switch Q7 and the reuse prohibition switch Q7 is turned on, whereby restoration of the battery operation is permitted.

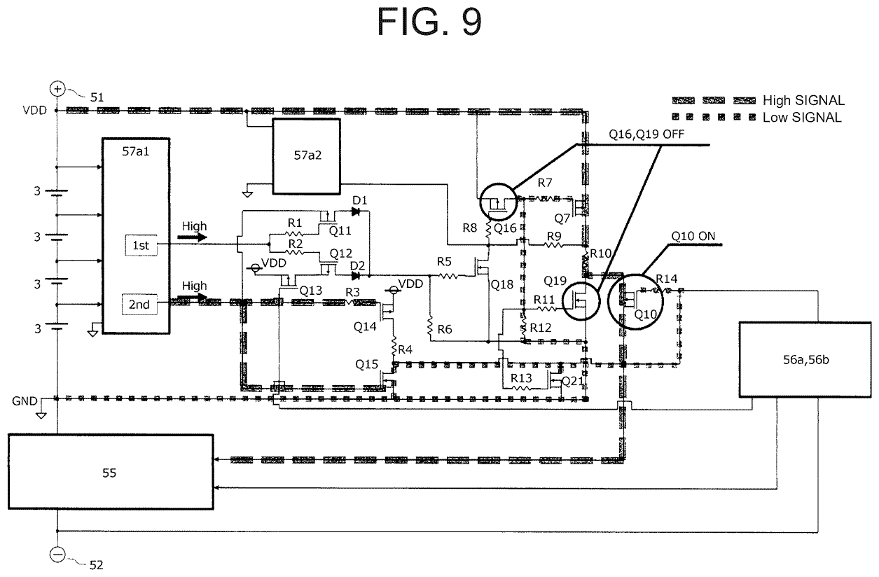

Next, with reference to FIG. 9, cancellation of the over-discharge protection, in other words, restoration of the battery operation, will be described.

When the voltage of the cell 3 becomes greater than or equal to an operation restoration threshold value, the output of the second terminal of the first monitoring circuit 57a1 changes from low to high. By this change, the switch Q14 is turned off and the switch Q15 is turned on, so that a low signal (corresponding to the signal (1) in FIG. 4) is input to the gate of the cutoff control switch Q10, and thus, the switch Q10 is turned on, and the cutoff portion 55 is turned on.

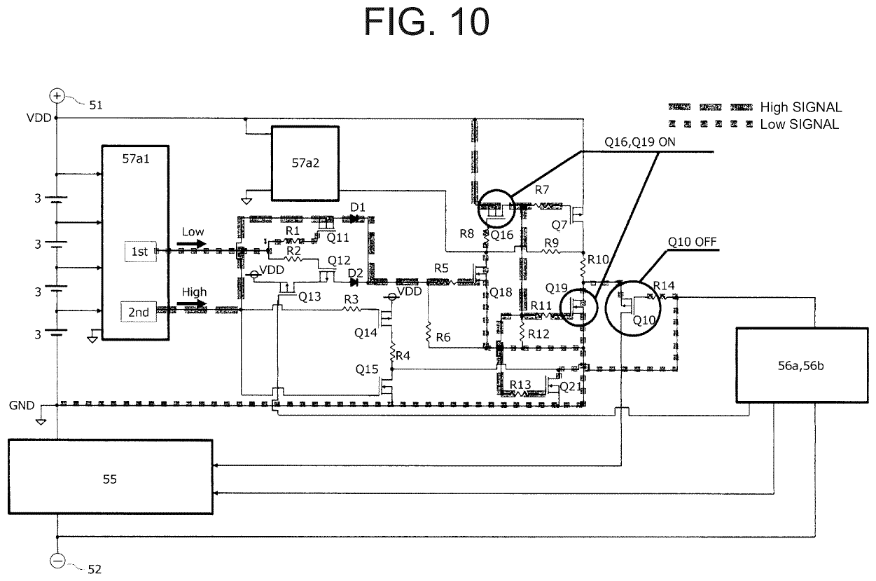

With reference to FIG. 10, the turning off of the cutoff portion 55 at the time of overvoltage protection whereby restoration of the battery operation is prohibited will be described.

When the voltage of a certain cell 3 becomes greater than or equal to a predetermined upper limit threshold value, an output of the first terminal of the first monitoring circuit 57a1 changes from high to low. Thus, the switch Q11 is turned on, and a high signal is input to the gate of the switch Q18 and the switch Q18 is turned on. As a result, a GND signal is input to the gate of the switch Q16 and the switch Q16 is turned on, the battery voltage VDD is input to the gates of the switches Q7, Q19 and Q21, and the reuse prohibition switch Q7 is latched in an off state (i.e., the reuse prohibition switch Q7 is turned off, and the switches Q19 and Q21 are turned on). The GND signal is input to the gate and the source of the cutoff control switch Q10 and the cutoff control switch Q10 is turned off, whereby the cutoff portion 55 is turned off.

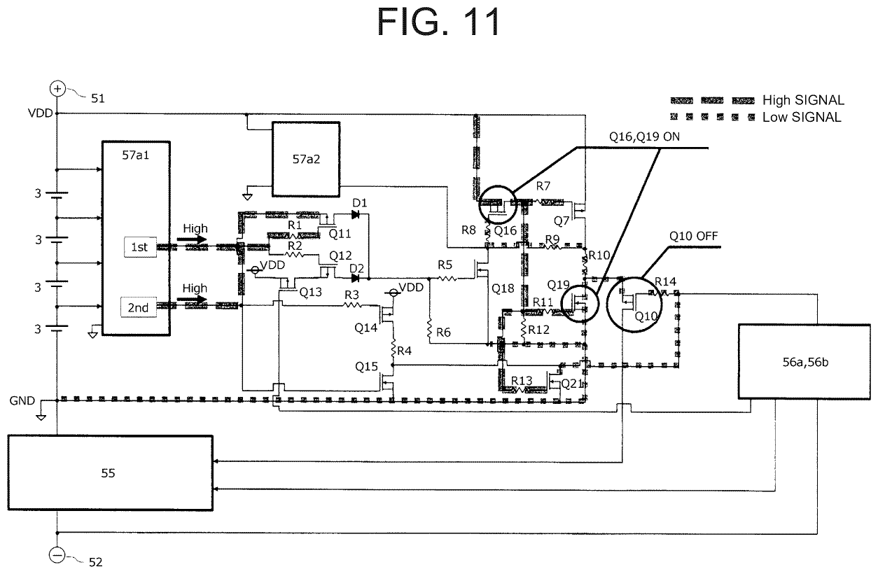

Next, with reference to FIG. 11, maintaining of the protection when the overvoltage is no longer exhibited will be described.

When the voltage of the cell 3 is lowered to a predetermined value or less and the state exits from the overvoltage state, the output of the first terminal of the first monitoring circuit 57a1 changes from low to high. By this change, while the switch Q11 is turned off, the GND signal is input to the gate of the switch Q16 and the switch Q16 remains turned on, and the reuse prohibition switch Q7 remains turned off. The switches Q19 and Q21 are also kept turned on, and the GND signal is given to the source and the gate of the cutoff control switch Q10. Hence, the reuse prohibition switch Q7 and the cutoff control switch Q10 are kept turned off, and restoration of the battery operation is prohibited.

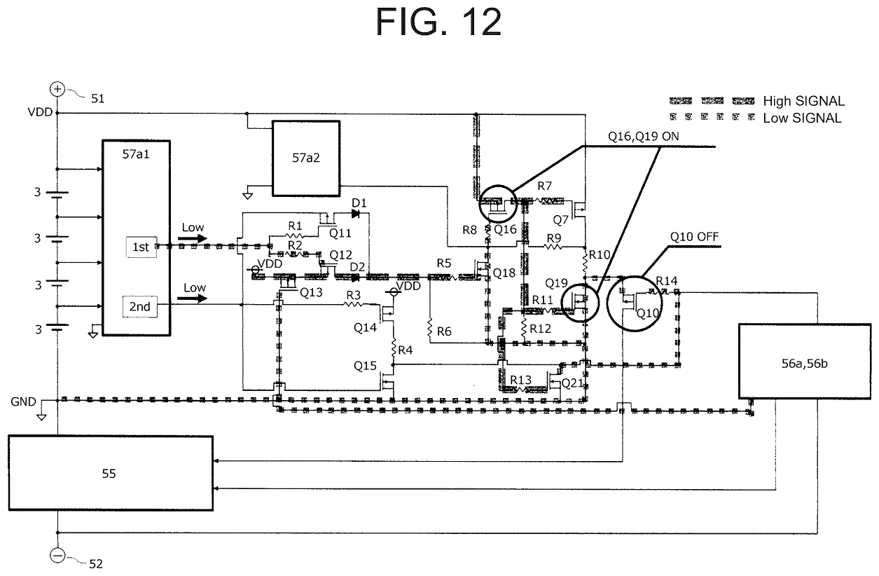

With reference to FIG. 12, the turning off of the cutoff portion 55 at the time of cell deep discharge protection whereby restoration of the battery operation is prohibited will be described.

When the voltage of a certain cell 3 becomes less than or equal to a predetermined lower limit threshold value, an output of the second terminal of the first monitoring circuit 57a1 changes, as in the case of FIG. 8, from high to low. After that, when the voltage of the cell 3 is further decreased and becomes less than or equal to a deep discharge threshold value, an output of the first terminal of the first monitoring circuit 57a1 changes from high to low, as illustrated in FIG. 12. Further, a low signal is given to the gate of the switch Q13 from the restoration function enabling portion 56b. Therefore, the switch Q12 is turned on, and a high signal is input to the gate of the switch Q18 and the switch Q18 is turned on. As a result, a GND signal is input to the gate of the switch Q16 and the switch Q16 is turned on, the battery voltage VDD is input to the gates of the switches Q7, Q19 and Q21, and the reuse prohibition switch Q7 is latched in an off state (i.e., the reuse prohibition switch Q7 is turned off, and the switches Q19 and Q21 are turned on). The GND signal is input to the gate and the source of the cutoff control switch Q10 and the cutoff control switch Q10 is turned off, whereby the cutoff portion 55 is turned off.

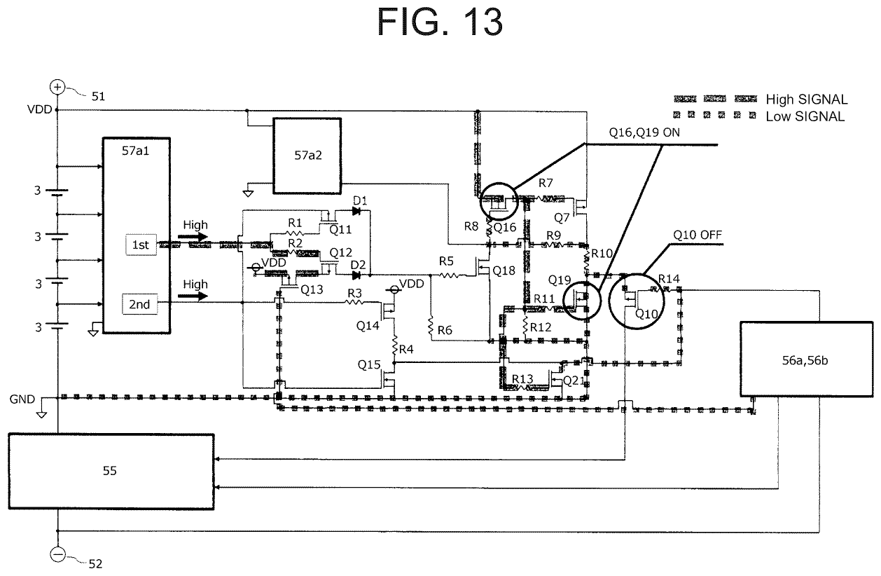

Next, with reference to FIG. 13, maintaining of the protection when the cell deep discharge is no longer exhibited will be described.

When the voltage of the cell 3 is increased to a predetermined value or more and the state exits from the deep discharge state, the outputs of the first terminal and the second terminal of the first monitoring circuit 57a1 both change from low to high. By this change, while the switch Q12 is turned off, the GND signal is input to the gate of the switch Q16 and the switch Q16 remains turned on, and the reuse prohibition switch Q7 remains turned off. The switches Q19 and Q21 are also kept turned on, and the GND signal is given to the source and the gate of the cutoff control switch Q10. Hence, the reuse prohibition switch Q7 and the cutoff control switch Q10 are kept turned off, and restoration of the battery operation is prohibited.

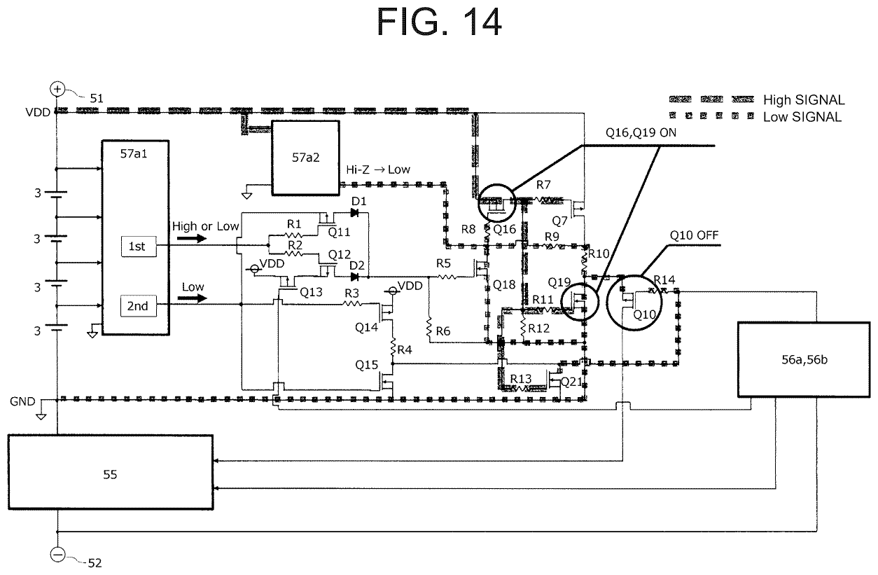

With reference to FIG. 14, the turning off of the cutoff portion 55 at the time of battery deep discharge protection whereby restoration of the battery operation is prohibited will be described.

When the battery voltage VDD becomes less than or equal to a predetermined lower limit threshold value, an output of the second monitoring circuit 57a2 changes from high impedance to low, and a low signal is input to the gate of the switch Q16 and the switch Q16 is turned on. As a result, the battery voltage VDD is input to the gates of the switches Q7, Q19 and Q21, and the reuse prohibition switch Q7 is latched in an off state (i.e., the reuse prohibition switch Q7 is turned off, and the switches Q19 and Q21 are turned on). A GND signal is input to the gate and the source of the cutoff control switch Q10 and the cutoff control switch Q10 is turned off, whereby the cutoff portion 55 is turned off.

In this way, by using the reuse prohibition switch Q7, the cutoff control switch Q10, and the switches Q16, Q19, and Q21 constituting the latch circuit, which are the same as those used in the cell deep discharge protection, the battery deep discharge protection is carried out.

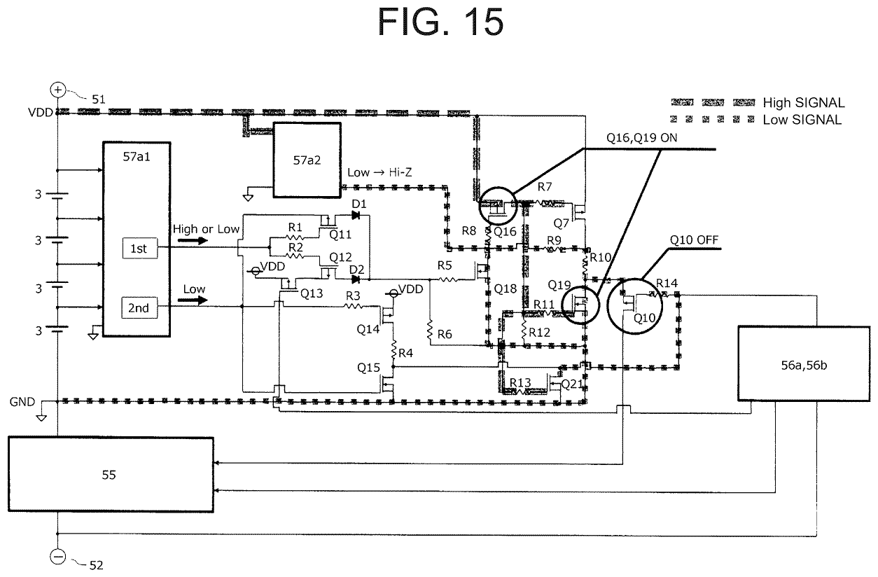

Next, with reference to FIG. 15, maintaining of the protection when the battery deep discharge is no longer exhibited will be described.

When the battery voltage VDD is increased to a predetermined value or more and the state exits from the deep discharge state, an output of the second monitoring circuit 57a2 changes from low to high impedance. A GND signal is input to the gate of the switch Q16 and the switch Q16 remains turned on, and the reuse prohibition switch Q7 remains turned off. The switches Q19 and Q21 are also kept turned on, and the GND signal is given to the source and the gate of the cutoff control switch Q10. Hence, the reuse prohibition switch Q7 and the cutoff control switch Q10 are kept turned off, and restoration of the battery operation is prohibited.

The present example embodiment is suitable for a system in which a semiconductor switch is mounted on a low side of an energy storage device. When the energy storage apparatus (battery) is required to have the function of executing cable communication with an external device (for example, a vehicle-side ECU), a ground (GND) potential of the BMU and a GND potential of the external device (equivalent to the potential of the negative terminal 52) must be the same potential. When the semiconductor switch is arranged on the low side and the semiconductor switch is turned off, the GND of the BMU and the negative terminal 52 corresponding to the GND of the external device are separated, and there is a possibility that normal communication cannot be performed. The battery 50 which is mounted on a motorcycle is not necessarily required to have the function of communicating with the vehicle-side ECU and the alternator 10B which serves as the vehicular battery charger. The present example embodiment is suitable for such an application.

By applying the present example embodiment to a battery for a motorcycle, it is possible to forcibly prevent use of a battery which is in a state in which restoration of the operation is not desirable (for example, a state in which a lithium-ion battery cell is overcharged, or a state in which the lithium-ion battery cell is deeply discharged).

When a low voltage abnormality (over-discharge) occurs, the cutoff portion is turned off in such a state that the battery can be used again, but when a deep discharge abnormality in which the voltage reduction has become even more serious since then occurs, the battery is prohibited from being used again. In this way, it is possible to promote safe operation of the battery while avoiding the battery from being frequently brought into a state in which the use is prohibited.

The present example embodiment is also suitable for a case where the energy storage apparatus (battery) is required to have the function of executing wireless communication with the external device. This is because with the wireless communication, communication can be executed even if the GND potential of the management controller 53 and the GND potential of the external device are not the same potential.

The present invention is not limited to the example embodiments described above.

The battery 50 may be mounted on an electric motorcycle which does not have an engine, and may supply the electric power of 12 V to the auxiliary machines. Alternatively, the battery 50 may be mounted on an automobile having an engine, an electric vehicle (EV), a hybrid electric vehicle (HEV), or a plug-in hybrid electric vehicle (PHEV). The battery may be mounted on other movable bodies such as a flying object, a railroad train, or a ship. The rated voltage of the battery is not limited to 12 V, and may also be 48 V or other voltages within the so-called “low voltage”range.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed:

1. An energy storage apparatus comprising:
an energy storage device;
a positive terminal and a negative terminal;
a power line connecting the positive terminal, the energy storage device, and the negative terminal to each other;
a first semiconductor switch and a second semiconductor switch provided in series on the power line; and
a protection circuit including a cutoff control switch connected to the first and second semiconductor switches to simultaneously turn off the first and second semiconductor switches, a reuse prohibition switch provided in series with the cutoff control switch, and a latch circuit; wherein
the protection circuit is configured to:
cause the first and second semiconductor switches to be turned off without latching the reuse prohibition switch by the latch circuit when executing first protection, which allows restoration of operation after the first and second semiconductor switches are turned off; and
cause the first and second semiconductor switches to be turned off while latching the reuse prohibition switch by the latch circuit when executing second protection, which prohibits the restoration of the operation after the first and second semiconductor switches are turned off.

2. An energy storage apparatus comprising:
an assembled battery including a plurality of energy storage devices;
a first monitoring circuit to monitor each of the energy storage devices and a second monitoring circuit to monitor the assembled battery;
a positive terminal and a negative terminal;
a power line connecting the positive terminal, the assembled battery, and the negative terminal to each other;
a first semiconductor switch and a second semiconductor switch provided in series on the power line;
a cutoff control switch connected to the first and second semiconductor switches to simultaneously turn off the first and second semiconductor switches;
a latch circuit; and
a reuse prohibition switch provided in series with the cutoff control switch to be latched by the latch circuit when a first abnormality is detected by the first monitoring circuit and when a second abnormality is detected by the second monitoring circuit, and to maintain a latched state even when at least one of the first abnormality or the second abnormality is resolved.

3. The energy storage apparatus according to claim 1, wherein the first and second semiconductor switches are provided in series on the power line between the energy storage device and the negative terminal.

4. The energy storage apparatus according to claim 1, further comprising a monitoring circuit to monitor the energy storage device, wherein the protection circuit is configured to execute the first protection or the second protection according to a combination of a first signal and a second signal that are respectively output from a first terminal and a second terminal of the monitoring circuit.

5. The energy storage apparatus according to claim 2, wherein the first abnormality is a deep discharge of the energy storage device, and the second abnormality is a deep discharge of the assembled battery.
